(19) United States
(12) Patent Application Publication
(10) Pub. No.: US 2012/0294757 A1
(43) Pub. Date: Nov. 22, 2012

(54) FILLER METAL FOR WELDING ALUMINUM MATERIAL AND MANUFACTURING METHOD THEREOF

(75) Inventors: Mun-Jin KANG, Goyang-si (KR); Dong-Cheol KIM, Incheon (KR); Jun-Ki KIM, Gunpo-si (KR); Cheol-Hee KIM, Incheon (KR); Se-Kwang KIM, Seoul (KR); Hoon CHO, Incheon (KR)

(73) Assignee: Korea Institute of Industrial Technology, Cheonan-si (KR)

(21) Appl. No.: 13/476,935

(22) Filed: May 21, 2012

(30) Foreign Application Priority Data
May 20, 2011 (KR) 10-2011-0048193

(51) Int. Cl. C22C 21/00; C22C 21/06; B23P 17/04; B21C 23/00; B21D 22/00

(52) U.S. Cl. 420/542; 72/362; 72/253.1; 72/343; 29/527.5; 420/528

(57) ABSTRACT

Provided are a filler metal for welding aluminum alloy materials and a manufacturing method thereof. The filler metal may include an aluminum matrix, and a calcium-based compound existing in the aluminum matrix.

### CROSS-REFERENCE TO RELATED PATENT APPLICATION

This application is related to U.S. Non-provisional application Ser. No. 12/949,152 (Attorney Docket Number 233YP-000400US) filed Nov. 18, 2010 and U.S. Non-provisional application Ser. No. 12/949,061 (Attorney Docket Number 233YP-000500US) filed Nov. 18, 2010, both of which are incorporated by reference.

This application claims the benefit of Korean Patent Application No. 10-2011-0048193 filed on May 20, 2011 in the Korean Intellectual Property Office, the disclosure of which is incorporated herein in its entirety by reference.

### BACKGROUND

The present invention relates to a filler metal used for welding metals, in particular a filler metal used for welding aluminum (Al) or Al alloy materials and manufacturing method thereof.

Bonding Al materials used for light materials are mainly performed through welding method. A large amount of heat needs to be quickly applied for Al welding, because Al has higher latent heat of fusion and higher heat conductivity although Al has lower melting temperature in comparison with iron (Fe). Furthermore, oxide films on the Al surface should be removed during Al welding, because they hinder Al welding. In consideration of these Al properties, it is important to choose an appropriate filler metal for Al welding. A filler metal is a metal used to bond materials together during welding process by fusing itself therebetween using heat generated during welding process.

The filler metal needs to have good working ability and generate no pore as a defect, in particular to generate as minimum number of cracks as possible. If welding materials are pure aluminums or Al alloys, 5000-series Al alloys having 2-5 wt % magnesium (Mg) or 4000-series Al alloys having less than 1 wt % Mg may mainly be used as filler metals.

### SUMMARY OF THE INVENTION

Although 6000-series or 7000-series Aluminum alloy has higher strength than 5000-series or 4000-series aluminum alloy, 6000-series or 7000-series Al alloy is seldom considered as filler metals because of the higher probability of generating welding crack owing to lack of ductility of the material.

The present invention provides a filler metal for welding aluminum alloy materials having improved ductility and thereby decreasing welding crack generation, and a manufacturing method of the filler metal.

A filler metal of an aluminum (Al) alloy for welding aluminum materials according to an aspect of the present invention may include an aluminum matrix, and a calcium-based compound existing in the aluminum matrix.

According to another aspect of the filler metal, magnesium (Mg) is dissolved in the aluminum matrix.

According to another aspect of the filler metal, magnesium is dissolved in an amount about 0.1% to about 18% by weight in the aluminum matrix. In an implementation, magnesium is dissolved in an amount no more than about 15% by weight in the aluminum matrix. In an implementation, magnesium is dissolved in an amount no more than about 10% by weight in the aluminum matrix.

According to another aspect of the filler metal, calcium is dissolved in an amount less than a solubility limit in the aluminum matrix.

According to another aspect of the filler metal, calcium is dissolved in an amount less than or equal to about 500 ppm in the aluminum matrix.

According to another aspect of the filler metal, the aluminum matrix has a plurality of domains which form boundaries therebetween and are divided from each other, and the calcium-based compound exists at least at the boundaries.

According to another aspect of the filler metal, the calcium-based compound may include at least one of a Mg—Ca compound, an Al—Ca compound, and a Mg—Al—Ca compound. Further, the Mg—Ca compound may include Mg₂Ca, the Al—Ca compound may include at least one of Al₂Ca and Al₄Ca, and the Mg—Al—Ca compound may include (Mg, Al)₂Ca.

According to another aspect of the filler metal, the aluminum matrix has grains having an average size that is smaller than another aluminum matrix manufactured under the same conditions but without the calcium-based compound

According to another aspect of the filler metal, the tensile strength of the filler metal having calcium-based compound is greater than that of another filler metal manufactured under the same conditions without the calcium-based compound.

According to another aspect of the filler metal, the elongation of the filler metal having calcium-based compound is greater than or equal to that of another filler metal manufactured under the same conditions without the calcium-based compound.

A method of manufacturing a filler metal for welding aluminum materials according to an aspect of the present invention may include plastically deforming an aluminum alloy to form the filler metal, wherein the aluminum alloy comprises an aluminum matrix and a calcium-based compound existing in the aluminum matrix.

According to another aspect of the method, wherein plastic deformation comprises extruding or drawing.

According to another aspect of the method, the aluminum alloy is manufactured by casting a melt which is formed by melting aluminum and a magnesium master alloy containing the calcium-based compound.

According to another aspect of the method, the magnesium master alloy is manufactured by adding a calcium-based additive to a parent material of pure magnesium or a magnesium alloy.

According to another aspect of the method, the calcium-based additive comprises at least one of calcium oxide (CaO), calcium cyanide (CaCN₂), and calcium carbide (CaC₂).

### BRIEF DESCRIPTION OF THE DRAWINGS

The above and other features and advantages of the present invention will become more apparent in view of exemplary embodiments described below with reference to the attached drawings in which:

FIG. 1 is a flowchart illustrating an embodiment of a method of manufacturing a magnesium master alloy to be added into a molten aluminum during the manufacture of an aluminum alloy according to embodiments of the present invention;

FIG. 2 shows analysis results of microstructures and components of a magnesium master alloy;

FIG. 3 is a flowchart illustrating an embodiment of a method of manufacturing an aluminum alloy according to the present invention;

FIG. 4 shows surface images of a molten aluminum alloy (a) in which a master alloy is prepared by adding calcium oxide (CaO) according to an embodiment of the present invention, and a molten aluminum alloy (b) into which pure magnesium has been added;

FIG. 5 shows surface images of a casting material for an aluminum alloy (a) from which a master alloy is prepared by adding CaO according to an embodiment of the present invention, and a casting material for a molten aluminum alloy (b) into which pure magnesium has been added;

FIG. 6 shows analysis results on components of an aluminum alloy (a) obtained by adding a master alloy with CaO according to an embodiment of the present invention, and components of a molten aluminum alloy (b) with pure magnesium added;

FIG. 7 shows an EPMA observation result (a) of a microstructure of an Al alloy obtained by adding a master alloy with CaO added according to an embodiment of the present invention, and component mapping results (b) to (e) of aluminum, calcium, magnesium and oxygen, respectively; and

FIG. 8 shows observation results on a microstructure of aluminum alloys (a) manufactured by adding a magnesium master alloy with CaO added into alloy 6061, and a microstructure of alloy 6061 (b) which is commercially available.

### DETAILED DESCRIPTION OF THE INVENTION

Hereinafter, the present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

In the embodiments of the present invention, a filler metal for welding aluminum materials refers to metal used for welding pure aluminums or aluminum alloys.

According to an embodiment of the present invention, a filler metal for welding aluminum materials is fabricated by plastically deforming an aluminum alloy, wherein the aluminum alloy is fabricated by casting a melt which is formed by melting a magnesium master alloy containing a calcium based compound and aluminum.

According to an embodiment of the present invention, a master alloy with a predetermined additive is prepared, and thereafter an aluminum alloy is manufactured by adding the master alloy into aluminum. The master alloy may use pure magnesium or magnesium alloy as parent material. The “magnesium master alloy” refers an alloy made using such a parent material.

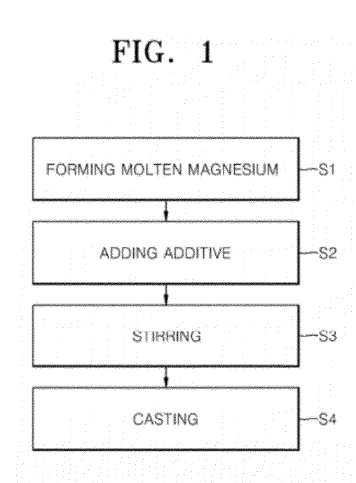

FIG. 1 is a flowchart showing a manufacturing method of magnesium master alloy in a manufacturing method of aluminum alloy according to an embodiment of the present invention.

Referring to FIG. 1, the manufacturing method of magnesium master alloy may include a molten magnesium forming operation S1, an additive adding operation S2, a stirring operation S3, and a casting operation S4.

In the molten magnesium forming operation S1, magnesium is put into a crucible and a molten magnesium is formed by melting magnesium.

In the additive adding operation S2, a Ca-based additive may be added into the molten magnesium which is a parent material. The calcium (Ca)-based additive added into the parent material may include one or more of compounds containing calcium. Examples of such compounds include calcium oxide (CaO), calcium cyanide (CaCN₂), and calcium carbide (CaC₂). Meanwhile, in the case where the Ca-based additive is added during the preparation of the magnesium master alloy, a small amount of a protective gas may be optionally provided in addition in order to prevent the molten magnesium from being ignited. However, this protective gas is not always necessary in the present invention, and thus may or may not be provided according to implementation. Accordingly, environmental pollution can be suppressed by eliminating or reducing the amount use of protective gas such as SF₆ or the like according to certain implementation of the present invention.

As the resistance for the oxidation of the molten magnesium is increased, incorporation of oxides or other inclusions are inhibited. Thus, the purity of the molten aluminum is improved, thereby improving the mechanical properties of the magnesium alloy casted from the molten magnesium.

Ca supplied from the Ca-based additive reacts with magnesium or other elements, such as aluminum in the melt to form various compounds. For example, the compounds include a Mg—Ca compound, an Al—Ca compound, a Mg—Al—Ca compound and others.

For example, Ca reacts with Mg to form Mg₂Ca as an example of the Mg—Ca compound. Meanwhile, in the case where the molten magnesium is fabricated using a magnesium alloy containing aluminum as an alloying element, Ca dissociated from the Ca-based additive reacts with aluminum in the molten magnesium to form Al₂Ca or Al₄Ca as an example of the Al—Ca compound, or reacts with aluminum and magnesium to form (Mg, Al)₂Ca as an example of the Mg—Al—Ca compound.

Then, in the operation of S3, the molten magnesium may be stirred to accelerate the reactions. After the stirring operation S3 of the molten parent material is completed, the molten magnesium is cast in a mold in operation S4. Then, the master alloy may be separated from the mold after cooling the mold to a room temperature; however, the master alloy may also be separated even before the temperature reaches room temperature if the master alloy is completely solidified.

Meanwhile, a calcium-based compound formed during the manufacturing process of the master alloy may be dispersed and exist in a matrix of the magnesium master alloy.

For example, in the case where the parent material of the magnesium master alloy is pure magnesium, the Ca-based compound which is possibly formed may be a Mg—Ca compound, for example, Mg₂Ca. As another example, in the case where the parent material of the magnesium master alloy is a magnesium alloy, for example, Mg—Al alloy, the Ca-based compound which is possibly formed may include at least one of a Mg—Ca compound, an Al—Ca compound, and a Mg—Al—Ca compound. For instance, the Mg—Ca compound may be Mg₂Ca, the Al—Ca compound may include at least one of Al₂Ca and Al₄Ca, and the Mg—Al—Ca compound may be (Mg, Al)₂Ca.

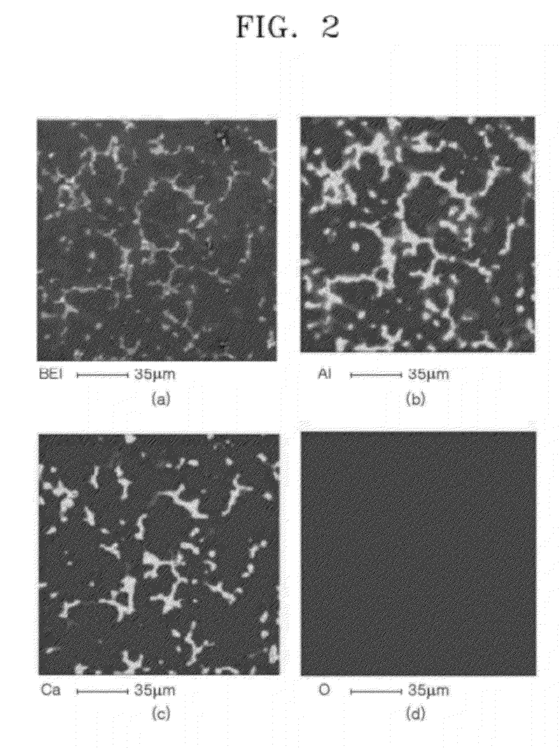

FIG. 2 represents the results of Electron Probe Micro Analyzer (EPMA) analysis of the magnesium master alloy which is manufactured by adding calcium oxide (CaO) as a Ca-based additive into a Mg—Al alloy.

Referring to FIG. 2, a microstructure of the magnesium master alloy observed using back scattered electrons is shown in FIG. 2(a). As shown in FIG. 2(a), the magnesium master alloy includes regions surrounded by compounds (bright areas), to form a polycrystalline microstructure. The compound (bright areas) is formed along grain boundaries. FIGS. 2(b) through 2(d) show the result of mapping components of the compound region (bright region) by EPMA, that is, the result of showing distribution areas of aluminum (b), calcium (c) and oxygen (d), respectively. As shown in FIGS. 2(b) and 2(c), aluminum and calcium were detected in the compound, respectively, but oxygen was not detected as shown in FIG. 2(d).

Hence, it was shown that an Al—Ca compound, which is formed by reacting Ca separated from calcium oxide (CaO) with Al contained in the parent material, is distributed at grain boundaries of the magnesium master alloy. The Al—Ca compound may be Al₂Ca or Al₄Ca, which is an intermetallic compound.

Meanwhile, the EPMA analysis result shows that Al—Ca compound is mainly distributed at grain boundaries of the magnesium master alloy. The Ca-based compound is distributed at grain boundaries rather than the inside regions of grains due to characteristics of the grain boundary having open structures. However, this analysis result does not limit the present embodiment such that the Ca-based compound is entirely distributed at the grain boundaries. In another embodiment, the Ca-based compound may be discovered within regions of grains (in the domains) depending on implementation.

The magnesium master alloy thus formed may be used for a purpose of being added to an aluminum alloy. As described above, the magnesium master alloy includes the Ca-based compound, which is formed by reacting Ca supplied from the Ca-based additive during an alloying process with Mg and/or Al. The Ca-based compounds are intermetallic compounds, and have a melting point that is higher than the melting point (658° C.) of Al. As an example, the melting points of Al₂Ca and Al₄Ca as Al—Ca compounds are 1079° C. and 700° C., respectively, which are higher than the melting point of Al.

Therefore, in the case where the master alloy containing such a Ca-based compound is inputted to a molten aluminum, the calcium compound may be mostly maintained without being melted in the melt. Furthermore, in the case where an aluminum alloy is manufactured by casting the melt, the Ca-based compound may be included in the aluminum alloy.

A manufacturing method of Al alloy according to an exemplary embodiment will be described in detail below. The manufacturing method may include providing a magnesium master alloy containing a Ca-based compound and aluminum, forming a melt in which a magnesium master alloy and aluminum are melted, and casting the melt.

For example, in order to form the melt with the Mg master alloy and melted Al, a molten Al is formed first by melting aluminum, and the Mg master alloy containing the Ca-based compound is added into the molten Al and then melted. As another example, a melt may be formed by loading the Al and the Mg master alloy together in a melting apparatus such as a crucible, and heating them together.

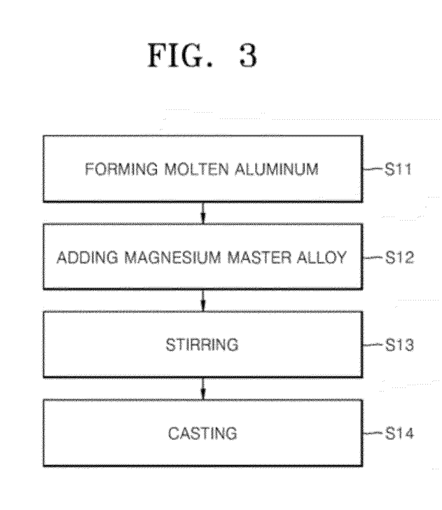

FIG. 3 illustrates an exemplary embodiment of a manufacturing method of an Al alloy according to the present invention. Specifically, FIG. 3 is a flowchart illustrating a manufacturing method of an Al alloy by using a process of forming a molten aluminum first, then adding the Mg master alloy manufactured by the above described method into the molten aluminum, and melting the Mg master alloy.

As illustrated in FIG. 3, the manufacturing method of the Al alloy may include a molten aluminum forming operation S11, a Mg master alloy adding operation S12, a stirring operation S13, and a casting operation S14. A cooling operation (not shown) may optionally be performed according to implementation.

In the operation S11, aluminum is put into a crucible and molten Al is formed by heating at a temperature ranging between about 600° C. and about 900° C. In the operation S11, aluminum may be any one selected from pure aluminum, aluminum alloy, and equivalents thereof. The Al alloy, for example, may be any one selected from 1000 series, 2000 series, 3000 series, 4000 series, 5000 series, 6000 series, 7000 series, and 8000 series wrought aluminum, or 100 series, 200 series, 300 series, 400 series, 500 series, and 700 series casting aluminum. Next, in the operation S12, the Mg master alloy manufactured according to the aforementioned method is added into the molten aluminum.

Next, in the optional operation of S13, the Mg master alloy is stirred to make the Mg master alloy be well mixed in the molten aluminum.

After stirring the molten aluminum, the molten aluminum is cast in a mold in operation S14. Explanation about casting methods will be omitted herein since the manufacturing method of the Mg master alloy has been already described in detail.

Therefore, according to the Al alloy manufacturing method of this embodiment, the quality of the melt may be improved significantly because the purity of the molten aluminium is greatly improved even without using a protective gas such as SF₆. After the casting is completed, a plurality of compounds which are incorporated within the Mg master alloy could be formed in the aluminium matrix without a separate thermal treatment. In other words, the Mg—Ca compound, the Al—Ca compound, the Mg—Al—Ca compound, etc. included in the Mg master alloy may be maintained in the molten aluminium and during the casting of the aluminium alloy, be formed in the aluminium matrix as a separate phase.

The aluminium alloy may have a matrix having a plurality of domains with boundaries therebetween, which are divided from each other. At this time, the plurality of domains divided from each other may be a plurality of grains which are divided by grain boundaries, and, as an another example, may be a plurality of phase regions having two of mutually different phases, wherein the plurality of phase regions are defined by phase boundaries therebetween.

Mg may be dissolved in aluminium in an amount up to about 17.4 wt % at 450° C. According to implementation, a selected amount of Mg is dissolved in the aluminium matrix by adding the Mg master alloy into a molten aluminium. A selected amount of Ca is added to the aluminium matrix according to implementation. In an embodiment, Ca is dissolved in an amount less than or equal to the solubility limit, for example 500 ppm.

The aluminium alloy according to the present invention may have improved mechanical properties attributed from the compounds dispersed in the matrix.

Meanwhile, the Ca-based compound may provide a site where nucleation occurs during the phase transition of the Al alloy from a liquid phase to a solid phase. That is, the phase transition from the liquid phase to the solid phase during solidification of aluminium alloy will be carried out through nucleation and growth. Since the Ca-based compound itself acts as a heterogeneous nucleation site, nucleation for phase transition to the solid phase is initiated at the interface between the Ca-based compound and the liquid phase. The solid phase, nucleated in this manner, grows around the Ca-based compound.

Also, Ca-based compound may be distributed at the grain boundaries between grains or the phase boundaries between phase regions. This is because such boundaries have open structures and have relatively high energy compared to inside areas of the grains or phase regions, and therefore, are favorable sites for nucleation and growth of the Ca-based compound.

Thus, in the case where the Ca-based compound is distributed at the grain boundaries or phase boundaries of Al alloy, an average size of the grains or phase regions may be decreased by suppressing the movement of grain boundary or phase boundary due to the fact that this Ca-based compound acts as an obstacle to the movement of grain boundaries or phase boundaries.

Therefore, the Al alloy according to the present invention may have grains or phase regions finer and smaller size on average when compared to the Al alloy that does not contain this Ca-based compound. Refinement of the grains or phase regions due to the Ca-based compound may improve the strength and elongation of the alloy simultaneously.

The aluminium alloy as mentioned above may be manufactured as filler metals having various shapes through plastic deformation. For example, the filler metals may have shapes of a solid wire, a cored wire, a bare rod, a covered electrode, etc.

For example, the aluminium alloy may be manufactured as a wire or a rod through extruding or drawing after the casting of the aluminium alloy. In more detail, a rod shape having a circular cross section may be processed by extruding the aluminium alloy and this rod shape may be processed as a filler metal having a line shape through drawing. As a result, the filler metal for welding aluminium materials could have a structure with the calcium-based compound dispersed in the aluminium matrix.

For another example, the cored wire may be fabricated to have a desired composition after welding by filling an appropriated kind of alloy powders into the strip of the aluminium alloy as mentioned above and drawing it.

Various advantages may be obtained by using the aluminium filler metal. For example, by using the filler metal, it may be possible to improve the strength of welding portion, inhibit the crack generation, improve the fatigue and impact toughness, and/or control the colour of the welding portion. In more detail, the filler metal fabricated using the aluminium alloy may have higher ductility and thus have improved welding properties as well as high strength of welding portion by dramatically inhibiting the crack generation in comparison with a conventional filler metal having the same magnesium composition. Since the aluminium alloy has superior ductility even though the content of magnesium is increased, it is possible to fabricate a filler metal having a higher strength and better welding properties.

Hereinafter, experimental examples will be provided in order to help the understanding of the present invention. The experimental examples described below are provided merely to illustrate the present invention and should not be used to limit the scope of the present invention.

Table 1 shows cast properties comparing an Al alloy manufactured by adding the Mg master alloy manufactured with addition of calcium oxide (CaO) as a Ca-based additive into aluminum (Experimental example 1) and an Al alloy manufactured by adding pure Mg without addition of a Ca-based additive in aluminum (Comparative example 1).

Specifically, Al alloy of the experimental example 1 was manufactured by adding 305 g of Mg master alloy into 2750 g of Al, and Al alloy of the comparative example 1 was manufactured by adding 305 g of pure Mg into 2750 g of Al. The Mg master alloy used in the experimental example employs a Mg—Al alloy as a parent material, and the weight ratio of calcium oxide (CaO) with respect to parent material was 0.3.

TABLE 1

| | Experimental | Comparative |
|---|---|---|
| | example 1 | example 1 |
| Dross amount | 206 g | 510 g |
| (impurity floating | | |
| on the melt surface) | | |
| Mg content in Al alloy | 4.89% | 2.65% |
| Melt fluidity | Good | Bad |
| Hardness (HR load 60 kg, | 92.6 | 92 |
| 1/16″ steel ball) | | |

Referring to Table 1, it has been shown that the amount of impurity floating on the melt surface (amount of Dross) represents remarkably smaller value when the Mg master alloy including Ca-based compound is added (experimental example 1) than when pure Mg without Ca-based compound is added (comparative example 1). Also, it was shown that Mg content in aluminum alloy is larger in experimental example 1 than in comparative example 1. Hence, it was shown that the loss of Mg is decreased remarkably in the case of the manufacturing method of the present embodiment as compared to the method of adding pure Mg.

Also, it was shown that fluidity of the melt and hardness of Al alloy is much improved under experimental example 1 than under comparative example 1.

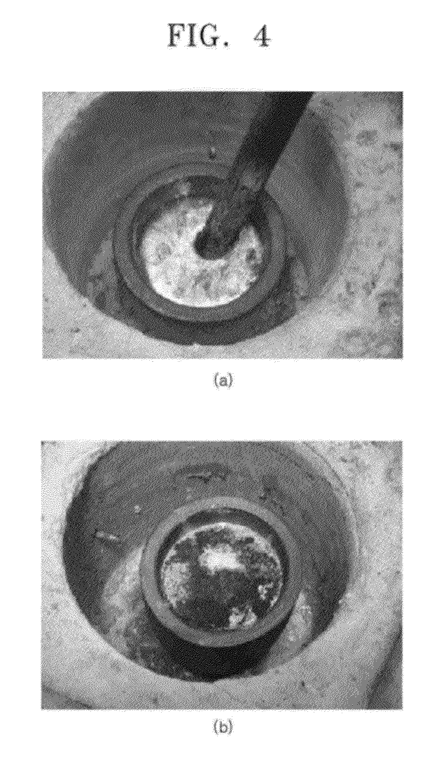

FIG. 4 shows the results of observing the melt condition according to the experimental example 1 and comparative example 1. Referring to FIG. 4, the melt condition is good in the experimental example 1 as shown in (a), but it was shown that the surface of the melt changes to black color due to oxidation of Mg in the comparative example 1 as shown in (b).

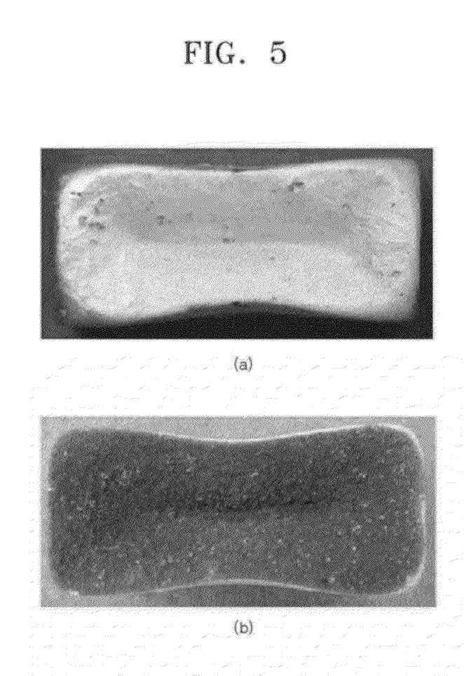

FIG. 5 shows the results of comparing the cast material surfaces of Al alloys prepared according to the experimental example 1 and comparative example 1. Referring to FIG. 5, it was confirmed that the surface of Al alloy casting material of the experimental example 1, as shown in (a), is cleaner than that of the Al alloy casting material of the comparative example 1 shown in (b).

This is due to the fact that castability is improved by calcium oxide (CaO) added during the fabrication of the Mg master alloy in the experimental example 1. That is, the Al alloy with pure Mg added without Ca-based compound (comparative example 1) shows ignition marks on the surface due to pure Mg oxidation during casting; however, a clean surface of an aluminum alloy may be obtained due to suppression of the ignition phenomenon in the Al alloy cast using the Mg master alloy with Ca-based compound (experimental example 1).

Hence, it may be observed that castability was improved by improvement of quality of the melt in the case of adding Mg master alloy when compared to the case of adding pure Mg.

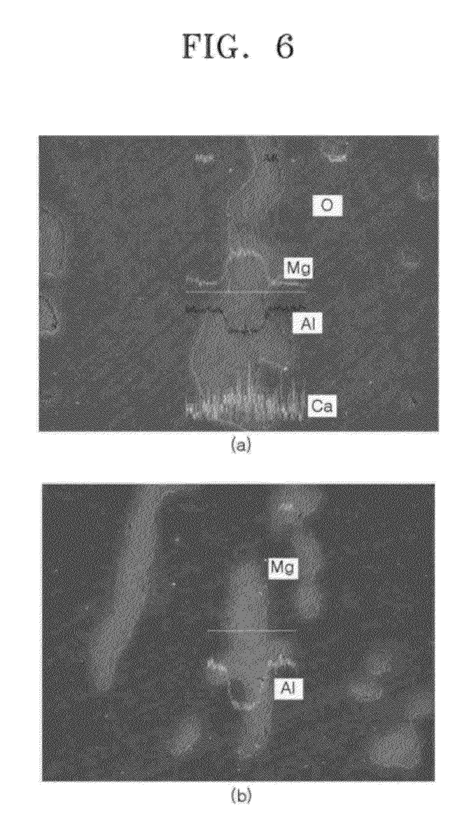

FIG. 6 shows the result of energy dispersive spectroscopy (EDS) analysis of Al alloys according to the experimental example 1 and comparative example 1 using a scanning electron microscopy (SEM). Referring to FIG. 6, only Mg and Al are detected in the Al alloy in which pure Mg of the comparative example 1 was added, as shown in (b). On the other hand, the presence of Ca is confirmed in the Al alloy in which the Mg master alloy having calcium oxide (CaO) of the experimental example 1 was added, as shown in (a). Also, it was shown that Mg and Al are detected at the same position and oxygen was barely detectable. Hence, it is believed that calcium exists as a Ca-based compound by reacting with Mg and/or Al after reducing from calcium oxide (CaO).

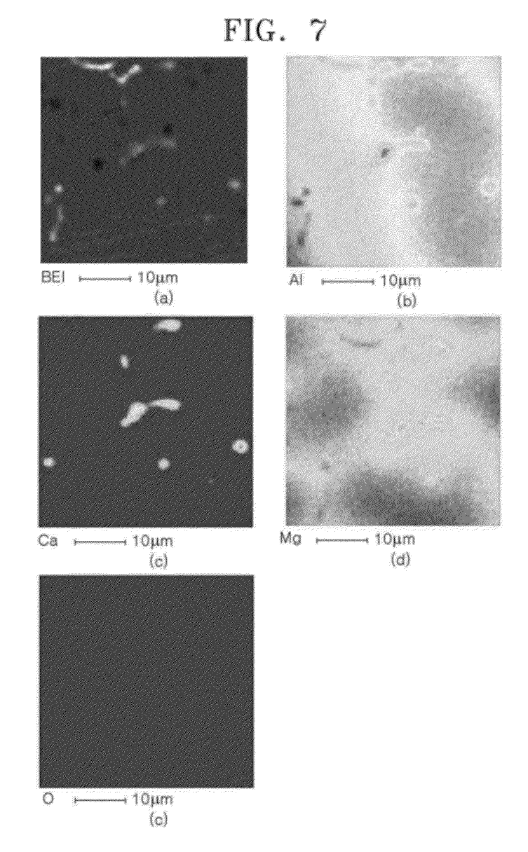

In FIG. 7(a), the EPMA observation result of microstructure of Al alloy of the experimental example 1 is presented, and in FIGS. 7(b) through 7(e), the respective mapping results of Al, Ca, Mg and oxygen are presented as the component mapping result using EPMA. As understood from FIGS. 7(b) to 7(d), Ca and Mg are detected at the same position in Al matrix, and oxygen was not detected as shown in FIG. 7(e).

This result is the same as the result of FIG. 6(a), and hence, it was confirmed again that Ca exists as a Ca-based compound by reacting with Mg and/or Al after reducing from calcium oxide (CaO).

Table 2 shows the mechanical properties Al alloys manufactured by adding the Mg master alloy, which was fabricated by adding calcium oxide (CaO) to the parent material, into 7075 alloy (experimental example 2) and 6061 alloy (experimental example 3). Commercially available Al alloys, with 7075 alloy and 6061 alloy that are manufactured without adding the Mg master alloy are used as comparative example 2 and 3, respectively. Samples according to experimental example 2 and 3 are extruded after casting, and T6 heat treatment was performed, and data of comparative example 2 and 3 refer to the values (T6 heat treatment data) in ASM standard.

TABLE 2

| | Tensile strength | Yield strength | Elongation |
|---|---|---|---|
| | (MPa) | (MPa) | (%) |
| Experimental example 2 | 670 | 600 | 12 |
| Comparative example 2 | 572 | 503 | 11 |
| Experimental example 3 | 370 | 330 | 17 |
| Comparative example 3 | 310 | 276 | 17 |

As listed in Table 2, it may be known that the aluminum alloy according to the present embodiment represent higher values in tensile strength and yield strength while superior or identical values in elongation when compared to the commercially available Al alloy. In general, elongation will be decreased relatively in the case where strength is increased in alloy. However, the Al alloy according to the present embodiment show an ideal property where elongation is also increased together with an increase in strength. As was described above, this result may be related to improvement in the cleanliness of the Al alloy melt.

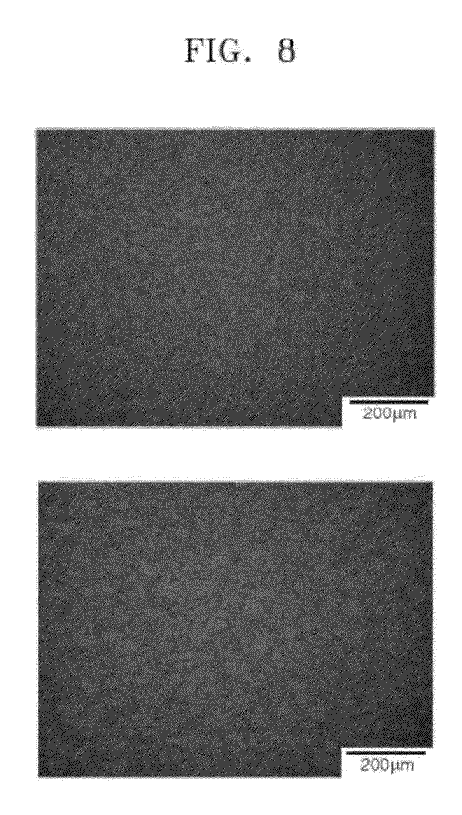

FIG. 8 represents the observation result of microstructures of alloys prepared according to experimental example 3 and comparative example 3. Referring to FIG. 8, it was observed that grains of Al alloy according to the present embodiment are exceptionally refined as compared to a commercial Al alloy. The grains in the Al alloy in FIG. 8(a), according to an embodiment of the present embodiment, have an average size of about 30 μm, and the grains in the commercially available Al alloy in FIG. 8(b), according to the comparative example, have an average size of about 50 μm.

Grain refinement in the Al alloy of the experimental example 3 is attributed to the fact that growth of grain boundary was suppressed by the Ca-based compound distributed at grain boundary or the Ca-based compound functioned as a nucleation site during solidification. It is considered that such grain refinement is one of the reasons why the Al alloy according to the present embodiment shows superior mechanical properties.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A filler metal of an aluminum (Al) alloy for welding aluminum materials, the filler metal comprising:
an aluminum matrix; and
a calcium-based compound existing in the aluminum matrix.

2. The filler metal of claim 1, further comprising:
magnesium (Mg) dissolved in the aluminum matrix.

3. The filler metal of claim 2, wherein an amount of magnesium in the aluminum matrix is about 0.1% to about 18% by weight.

4. The filler metal of claim 2, wherein calcium is dissolved in an amount less than a solubility limit in the aluminum matrix.

5. The filler metal of claim 4, wherein calcium is dissolved in an amount less than or equal to about 500 ppm in the aluminum matrix.

6. The filler metal of claim 1, wherein the aluminum matrix comprises at least one selected from the group consisting of 1000 series, 2000 series, 3000 series, 4000 series, 5000 series, 6000 series, 7000 series, and 8000 series wrought aluminum.

7. The filler metal of claim 1, wherein the aluminum matrix has a plurality of domains which form boundaries therebetween,
wherein the calcium-based compound exists at least at the boundaries.

8. The filler metal of claim 1, wherein the calcium-based compound comprises a Mg—Ca compound, an Al—Ca compound, a Mg—Al—Ca compound, or a combination thereof.

9. The filler metal of claim 8, wherein the Mg—Ca compound comprises Mg₂Ca.

10. The filler metal of claim 8, wherein the Al—Ca compound comprises Al₂Ca, Al₄Ca, or both.

11. The filler metal of claim 8, wherein the Mg—Al—Ca compound comprises (Mg, Al)₂Ca.

12. The filler metal of claim 1, wherein the calcium-based compound is added to decrease an average grain size of the aluminum matrix.

13. The filler metal of claim 1, wherein the calcium-based compound is added to increase a tensile strength of the filler metal.

14. The filler metal of claim 1, wherein the filler metal has a tensile strength greater than and an elongation greater than or equal to another filler metal not having the calcium-based compound which is manufactured under the same conditions.

15. A method of manufacturing a filler metal for welding aluminum materials, the method comprising:
plastically deforming an aluminum alloy to form the filler metal,
wherein the aluminum alloy comprises an aluminum matrix and a calcium-based compound existing in the aluminum matrix.

16. The method of claim 15, wherein the plastically deforming comprises extruding or drawing.

17. The method of claim 15, wherein the aluminum alloy is manufactured by casting a melt which is formed by melting aluminum and a magnesium master alloy containing the calcium-based compound.

18. The method of claim 17, wherein the aluminum is pure aluminum or an aluminum alloy.

19. The method of claim 17, wherein the magnesium master alloy is manufactured by adding a calcium-based additive to a parent material of pure magnesium or a magnesium alloy.

20. The method of claim 19, wherein the calcium-based additive comprises calcium oxide (CaO), calcium cyanide (CaCN₂), calcium carbide (CaC₂), or a combination thereof.
